(19) United States
(12) Patent Application Publication
(10) Pub. No.: US 2026/0243112 A1
(43) Pub. Date: Aug. 20, 2026

(54) MOTOR VEHICLE DOOR CLOSING SYSTEM AND METHOD

(71) Applicant: AUDI AG, Ingolstadt (DE)

(72) Inventors: Jürgen HLADIK, Altmannstein (DE); Harald HOFERER, Burgstall (DE); Bernhard SCHWANTNER, Eichstätt (DE)

(73) Assignee: AUDI AG, Ingolstadt (DE)

(21) Appl. No.: 19/530,607

(22) Filed: Feb. 5, 2026

(30) Foreign Application Priority Data
Feb. 19, 2025 (DE) 102025106286.2

(51) Int. Cl. E05B 81/62; E05B 81/04; E05B 81/80

(52) U.S. Cl. CPC E05B 81/62; E05B 81/04; E05B 81/80

(57) ABSTRACT

A motor vehicle door closing system includes a body, a door, a signaling unit, an emergency power source, a power source, an electrical control unit, a control, and a closing unit. The closing unit has a rotary latch and a locking bar. The locking bar is located on the body and the rotary latch is in the door. The rotary latch has a receiving region designed to complement the locking bar. The power source and the emergency power source are connected to the electrical control unit. The electrical control unit controls the rotary latch. In the passive state, the receiving region has a distance to the locking bar. The closing unit is designed in an unlocked state such that the locking bar is arranged in the receiving region and movement of the locking bar into the passive state is possible. The rotary latch has a closed position.

### FIELD

The invention relates to a door closing system, a motor vehicle, and a method for closing a door.

### BACKGROUND

The development of modern vehicle door systems represents a key challenge in automotive engineering, particularly with regard to safety and reliability. In emergency situations, such as a vehicle crash, door systems must meet special requirements to both protect the occupants and facilitate rescue operations. A particular difficulty arises when the vehicle electrical system fails due to damage or interruptions, rendering electronic door locking and unclosing systems inoperable.

Modern vehicle door systems are designed to unlock with a crash signal in the event of an accident to facilitate access to the vehicle interior. However, in a severe accident with high structural intrusion, the primary vehicle electrical system may fail. In such cases, mechanical door interior and exterior controls remain functional, while electrical controls can only be used if an emergency power supply is available. This emergency power supply must be designed to provide sufficient energy for a specified number of door openings or a certain operating time after the accident.

In DE 10 2021 102 595 A1 a motor vehicle lock is disclosed which can be operated electrically on the one hand and mechanically on the other. In the event of a crash, the vehicle door can be mechanically unlocked via a mechanical coupling element. The coupling element is extracted in the normal state and is inserted in the crash state using a mass inertia element, thus activating the mechanical unlocking.

DE 10 2016 220 142 A1 discloses a lock assembly of a vehicle door which has a mechanical emergency release. The lock assembly has a release lever for this purpose. In the event of an emergency unlocking, the unlocking lever is prevented from returning to a locked position by means of a holding lever, so that occupants of the vehicle can leave the vehicle after a crash with a power failure of the vehicle electrical system.

In DE 10 2020 123 596 A1 an opening device for a motor vehicle door is disclosed which has an emergency power supply. This opening device is integrated into the vehicle electrical system. The emergency power supply enables the opening mechanism of the vehicle door element to be activated in the event of a failure of the primary electrical system or a voltage drop in the primary electrical system.

A problem arises when the door is opened and closed multiple times after an accident, such as the driver door of a damaged vehicle parked on the side of a busy road. In such cases, the opening mechanism may no longer function after the emergency power supply is exhausted, which can result in the door no longer being able to be opened. This poses a significant obstacle to rescue and recovery operations.

Increasing the operating time or the number of possible door openings through a larger emergency power supply comes with disadvantages. In particular, this requires additional installation space, leads to block formation within the door and increases the weight of the system, which can negatively affect vehicle design and efficiency.

### SUMMARY

The object of the invention is therefore to improve an electric door closing system with an emergency power supply in such a way that, while avoiding the aforementioned disadvantages, reliable access from the outside to the vehicle occupants is ensured following a crash.

In a known manner, a motor vehicle door closing system comprises a body, a door, a signaling unit, an emergency power source, a power source, an electrical control unit, a control unit, and a closing unit. The closing unit features a rotary latch and a locking bar. The locking bar is located on the body and the rotary latch is in the door. The rotary latch has a receiving region. The receiving region is designed to complement the locking bar. The power source and the emergency power source are connected to the electrical control unit. The electrical control unit controls the rotary latch. The electrical control unit is in particular an electric motor. Controlling this can involve moving the rotary latch. It is therefore an electrically operated door closing system, wherein the closing system is operated by the actuation of an electrical control element, for example a push button. In the passive state, the receiving region has a distance to the locking bar. The closing unit is designed in an unlocked state such that the locking bar is arranged in the receiving region and movement of the locking bar into the passive state is possible. This is done by an activation signal from the inside or outside door mechanism. The rotary latch has a closed position. The receiving region of the rotary latch is closed in the radial direction when in the closed position. The receiving region is therefore not accessible from the outside. The rotary latch is locked in the closed position. The control unit is connected to the power source, the emergency power source and the signaling unit via signal technology. The electrical control unit controls the rotary latch in such a way that it can be moved into and out of a closed position. The emergency power source supplies the electrical control unit in an emergency situation. If there is no emergency situation, the electrical control unit is supplied with power via the power source. An emergency situation occurs when the voltage of the power source drops while the vehicle is ready to drive. In the event of an emergency, the signaling unit generates a signal so that the control switches the power supply of the electrical control unit from the main power source to the emergency power source.

According to the invention, a locking element with an active state is provided. The locking element is located on the door and/or on the body. In the passive state and the emergency state, the locking element is in the active state. The locking element is designed in the active state such that the closing unit is in the unlocked or passive state. This ensures that the door remains permanently open in the event of a power failure. In the event of an accident, this ensures that the interior of the vehicle can be reliably accessed for the rescue and recovery of vehicle occupants.

According to a further advantageous embodiment of the invention, the rotary latch is designed as a locking element. In the active state of the rotary latch and in the passive state of the closing unit, the rotary latch is in the closed position. This provides a simple way to integrate a locking element into the door closing system by additionally designing the existing rotary latch as a locking element and maintaining the passive state when the door is open.

Preferably, the locking element is designed as a rotary latch. The locking element is designed in the active state such that the closing unit is in the unlocked state. The rotary latch can be moved in such a way that it can partially or completely encircle a locking bar located in the receiving region. However, the rotary latch does not lock into the closed position, so the locking bar can still be moved out of the receiving region.

Preferably, the locking element is designed such that, in the active state of the locking element, the receiving region of the rotary latch is open. The rotary latch is locked in this open position. The locking bar can therefore be moved into and out of the receiving region of the rotary latch when the locking element is in its active state. The door remains open.

According to a further advantageous embodiment of the invention, the locking element is arranged on the body or on the door. The locking element is designed as a spacer element and extends in the active state between the body and the door. The spacer element can be designed as a stamp or plunger that interacts with the door in such a way that the closing unit remains in a passive state, so that the locking bar has a distance to the receiving region of the rotary latch.

The locking element can also be designed as a spacer element on the door, wherein the spacer element prevents the locking bar from being moved into the receiving region of the rotary latch. The locking element can be designed as a plunger or ram, which locks the rotary latch in the active state. This allows the locking element to be easily integrated into the existing closing unit.

The door closing system is designed in such a way that a reset option is provided to return the locking element from an active state to a passive state, so that regular operation of the closing unit is possible after an accident or rescue and the door can be closed and locked again.

Another aspect of the invention relates to a motor vehicle with at least one vehicle door, a door frame and a door closing system. According to the invention, the door closing system is designed as described.

Another aspect of the invention relates to a method for actuating a door closing system of a motor vehicle, comprising the following steps:
generating a first signal due to a motor vehicle accident by a signaling unit;
generating a second signal by the signaling unit due to the failure of the power source;
establishing the emergency state by switching the control from the power source to the
emergency power source to supply the electrical control unit based on the second signal;
establishing the unlocked state of the closing unit based of the first signal;
establishing a passive state by opening the door, for example by vehicle occupants or first responders;
establishing the active state of the locking element based on the second signal.

According to the invention, the door closing system is designed as described.

### BRIEF DESCRIPTION OF THE DRAWINGS

Further advantages and possible uses of the invention will be apparent from the following description in conjunction with embodiments shown in the drawings.

FIG. 1 shows a schematic view of the door closing system, and

FIG. 2 shows a schematic side view of a closing unit according to the invention, wherein the rotary latch is in the closed position.

### DETAILED DESCRIPTION

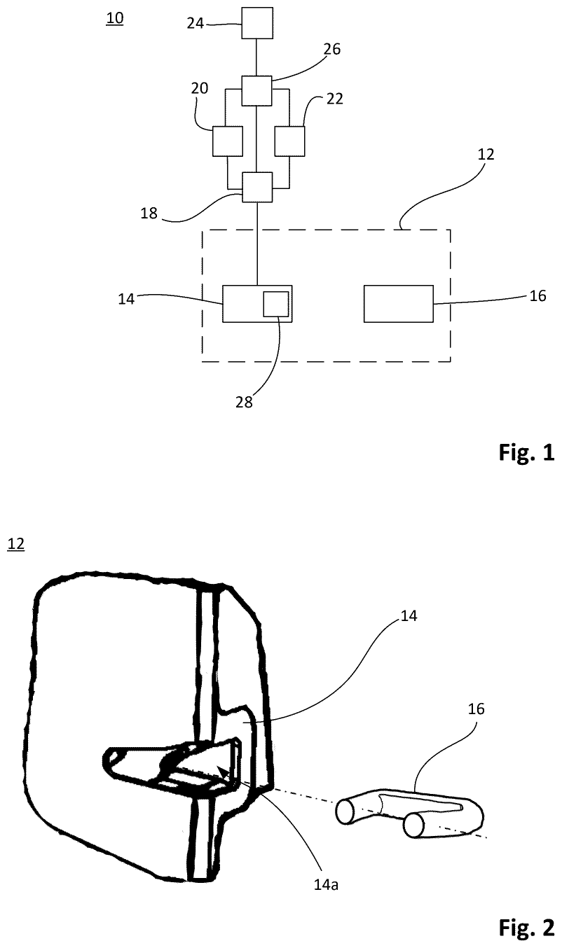

FIG. 1 shows a schematic view of the door closing system 10. The door closing system 10 has a closing unit 12. The closing unit 12 comprises a rotary latch 14 and a locking bar 16. The rotary latch 14 and the locking bar 16 work together in such a way as to close or open a motor vehicle door. The rotary latch 14 is located in the door and the locking bar 16 is in the body.

The rotary latch 14 is connected to an electrical control unit. The electrical control unit is designed as an electric motor 18. The electric motor 18 controls the movement of the rotary latch or unlocks it. The electric motor 18 controls the rotary latch 14 in such a way that it can be moved into and out of a closed position.

Furthermore, a power source 20 and an emergency power source 22 are provided.

The power source 20 supplies the electric motor 18 with electricity during normal operation of the motor vehicle.

A signaling unit 24 is also provided. The signaling unit 24, the power source 20, the emergency power source 22 and the electric motor 18 are connected with a control 26 via signal technology.

The signaling unit 24 can be designed as part of a door control system arranged in the door.

FIG. 2 shows a schematic side view of the closing unit 12, with the rotary latch 14 in an open position. The rotary latch 14 has a receiving region 14a which is designed to be complementary to the locking bar 16. The receiving region 14a is accessible in the open position for the locking bar 16. The locking bar 16 is located outside the receiving region 14a of the rotary latch 14. A gap is formed between the locking bar 16 and the receiving region 14a. The closing unit 12 is in passive mode.

In the closed position of the rotary latch 14, the receiving region 14a of the rotary latch 14 is closed to the outside. If the locking bar 16 is located outside the receiving region 14a, it cannot be moved into the receiving region 14a, so that the passive state of the closing unit 12 is maintained.

If the locking bar 16 is located in the receiving region 14a of the rotary latch 14 when the rotary latch 14 is switched to the closed position, then the door is closed or locked. The rotary latch 14 is also locked in the closed position, so the locking bar 16 cannot be moved out of the receiving region 14a. The locking bar 16 is fixed in the receiving region 14a and the door is locked.

The closing unit 12 also has an unlocked state. In the unlocked state, the locking bar 16 is arranged in the receiving region 14a of the rotary latch 14. The rotary latch 14 can at least partially enclose the locking bar 16. The locking bar 16 can be moved out of the receiving region 14a of the rotary latch 14, since the rotary latch 14 is not locked in the closed position.

By moving the rotary latch 14 by means of the electric motor 18, the unlocked state of the closing unit 12 and the closed position of the rotary latch 14 can be established.

In the event of a crash of the motor vehicle, the signaling unit 24 generates a first signal, the crash signal, which is sent to the control 26. The control 26 controls the electric motor 18 so that the rotary latch 14 switches to the unlocked state. The door is now unlocked and can be opened.

In the event of a failure of the power source 20 or a voltage drop of the power source 20 due to the crash of the motor vehicle, the signaling unit 24 generates a second signal that is sent to the control 26. The control 26 causes the power supply of the electric motor 18 to be switched from the power source 20 to the emergency power source 22. The closing unit 12 is in emergency mode.

Two different signaling units 24 can also be configured for the first and second signals.

A locking element 28 is provided. The locking element 28 is located on the door and/or on the body. The locking element 28 is located in the region of the rotary latch 14 and/or the locking bar 16 and extends between the door and the body. The locking element 28 can also be located at any other point on the door and/or body to prevent the locking bar 16 from falling into the rotary latch 14. Furthermore, the locking element 28 can be designed as a rotary latch 14.

If the door is opened in an emergency, i.e., the passive state of the closing unit 12 is established, the locking element 28 is in the active state and prevents the closing unit 12 from returning to the locked state of the door.

In the embodiment according to FIG. 1, the rotary latch 14 is designed as a locking element 28. The rotary latch 14 can be controlled by the electric motor 18, however, the rotary latch 14 does not engage, so that the unlocking state of the closing unit is formed during the active state of the locking element 28 and a closed position of the rotary latch cannot be established. The door is now unlocked and can be opened.

In another embodiment, the rotary latch 14 is designed as a locking element 28, wherein the rotary latch 14 changes to the closed position in the active state of the locking element 28. The receiving region 14a of the rotary latch is closed, so that the locking bar 16 cannot be moved into the receiving region 14a. The door remains open and the closing unit 12 remains in passive mode.

In another embodiment, the rotary latch 14 is designed as a locking element 28, wherein the rotary latch 14 locks in an open position in the active state of the locking element 28. In the open position of the rotary latch 14, the receiving region 14a is accessible from the outside. The locking bar 16 can therefore be moved into and out of the receiving region 14a without the rotary latch 14 changing into the closed position. The door will therefore remain open.

Furthermore, the locking element 28 can also be formed on the body in the region of the locking bar 16 and extends between the door and the body. The locking element 28 can also be located in other regions of the door and/or body, wherein the locking element 28 is arranged in such a way that the locking bar 16 cannot fall into the rotary latch 14. The locking element 28 is designed as a spacer element and axially extends in the active state from the body towards the door. For example, it can be extended while in the active state. The locking element 28 is then designed in the active state such that it counteracts the closing of the door and maintains the distance between the receiving region 14a of the rotary latch 14 and the locking bar 16, so that the closing unit 12 remains in the passive state.

The design of the door closing system 10 according to the invention makes it possible in a simple way to ensure that, in the event of a failure of the primary power supply or the vehicle electrical system as a result of a crash, electrically operated doors of a motor vehicle remain reliably and permanently open, so that the vehicle interior remains accessible for rescue or recovery operations, for example.

1. A door closing system of a motor vehicle, comprising: a body, a door, a signaling unit, an emergency power source, a power source, an electrical control unit, a control, and a closing unit, wherein the closing unit has a rotary latch and a locking bar, wherein the locking bar is arranged on the body and the rotary latch is arranged in the door, wherein the rotary latch has a receiving region, wherein the receiving region is designed to be complementary to the locking bar, wherein the power source and the emergency power source are connected to the electrical control unit, wherein the electrical control unit controls the rotary latch, wherein in the passive state the locking bar has a distance to the receiving region, wherein the closing unit is configured in an unlocked state such that the locking bar is arranged in the receiving region and allows the locking bar to move into the passive state, wherein the rotary latch has a closed position, wherein the receiving region of the rotary latch is closed in the radial direction in the closed position and the rotary latch is locked, wherein the control unit is connected to the power source, the emergency power source and the signaling unit via signaling, wherein the electrical control unit controls the rotary latch such that it can be moved into and out of a closed position, wherein the emergency power source supplies the electrical control unit in an emergency state, wherein the signaling unit generates a signal in the event of an emergency state so that the control unit switches the power supply of the electrical control unit from the power source to the emergency power source, wherein a locking element with an active state is provided, wherein the locking element is arranged on the door and/or on the body, wherein the locking element, when the passive state and the emergency state are present, is in the active state, and wherein the locking element is designed in the active state such that the closing unit is in the unlocked or passive state.

2. The door closing system according to claim 1, wherein the rotary latch is designed as a locking element, wherein in the active state of the rotary latch and in the passive state of the closing unit the rotary latch is designed in the closed position.

3. The door closing system according to claim 1, wherein the rotary latch is designed as a locking element, wherein in the locking element is designed such that the closing unit is in the unlocked state in the active state of the locking element.

4. The door closing system according to claim 3, wherein the locking element is designed such that in the active state of the locking element the receiving region of the rotary latch is open.

5. The door closing system according to claim 1, wherein the locking element is arranged on the body or door, wherein the locking element is designed as a spacer element and extends from the body towards the door in the active state.

6. The door closing system according to claim 1, wherein a door control system is provided in the door, wherein the door control system comprises the signaling unit.

7. A motor vehicle with at least one vehicle door, a body and a door closing system, wherein the door closing system is designed according to claim 1.

8. A method for actuating a door closing system of a motor vehicle, wherein the door closing system is configured according to claim 1, comprising the following steps:
generating a first signal due to an accident of the motor vehicle by a signaling unit;
generating a second signal by the signaling unit due to the failure of the power source;
establishing the emergency state by switching the control from the power source to the emergency power source to supply the electrical control unit due to the second signal;
establishing the unlocked state of the closing unit due to the first signal;
establishing the passive state by opening the door;
establishing the active state of the locking element due to the second signal.

9. The door closing system according to claim 2, wherein a door control system is provided in the door, wherein the door control system comprises the signaling unit.

10. The door closing system according to claim 3, wherein a door control system is provided in the door, wherein the door control system comprises the signaling unit.

11. The door closing system according to claim 4, wherein a door control system is provided in the door, wherein the door control system comprises the signaling unit.

12. The door closing system according to claim 5, wherein a door control system is provided in the door, wherein the door control system comprises the signaling unit.
